(19) United States
(12) Patent Application Publication
(10) Pub. No.: US 2011/0226684 A1
(43) Pub. Date: Sep. 22, 2011

(54) Water Purification System and Apparatus

(75) Inventors: Lee Underwood, Bucks (GB); Jonathan Fleisig, Bucks (GB)

(73) Assignee: VELIA WATER SOLUTIONS & TECHNOLOGIES SUPPORT

(21) Appl. No.: 13/123,871

(22) PCT Filed: Oct. 15, 2009
(86) PCT No.: PCT/GB2009/051378

§ 371 Date: Apr. 12, 2011

(30) Foreign Application Priority Data
Oct. 16, 2008 (GB) 0818935.9

(51) Int. Cl. B01D 21/30

(52) U.S. Cl. 210/141

(57) ABSTRACT

A water purification system including at least: a water purification apparatus comprising one or more water purification components to provide a purified water stream, the apparatus having one or more user-operable controls; a programmable controller in the water purification apparatus, and connected to the user-operable control(s) for receiving control commands from the controls, the programmable controller configured to control the water purification apparatus in response to the control commands; and a data interface for receiving a remote operator program from a detachable communication device for controlling operation of the apparatus.

The present invention relates a water purification system and apparatus, particularly, but not exclusively for laboratory water.

Water purification systems and apparatus for use in laboratories and healthcare facilities are well known. Generally they involve the reduction and/or removal of contaminants and impurities to low levels. They typically contain a variety of technologies that remove particles, colloids, ionic species and organic substances and/or molecules.

Water purification apparatus generally have one or more controls operable by a user to vary certain operations of the apparatus, such as volume and flow rate of the dispense of the water.

Due to the complexity of water purification apparatus, and the need to maintain a certain security of its operations to maintain performance of the apparatus, the user is unable to vary or view others operations or data of the apparatus that are accessible and/or variable by a service engineer. However, this requires a service engineer to be present for all requirements of the water purification apparatus beyond the user's remit, including any changes to the component settings, calibrations, updating and any special dispense programming.

It is an object of the present invention to provide a water purification system and apparatus which has a remote operator relationship.

According to one aspect of the present invention, there is provided a water purification system comprising at least:

(a) a water purification apparatus comprising one or more water purification components to provide a purified water stream, preferably having a conductivity of less than 1 μS/cm, the apparatus having one or more user-operable controls;
(b) a programmable controller in the water purification apparatus, and connected to the user-operable control(s) for receiving control commands from the controls, the programmable controller configured to control the water purification apparatus in response to the control commands; and
(c) a data interface for receiving a remote operator program from a detachable communication device for controlling operation of the apparatus.

According to another aspect of the present invention, there is provided a method of remote programming a water purification apparatus comprising at least the steps of:

(a) providing a water purification apparatus comprising one or more water purification components to provide a purified water stream, preferably having a conductivity of less than 1 μS/cm, a programmable controller in the water purification apparatus, and a data interface for receiving a remote operator program from a detachable communication device to program the programmable controller; and
(b) programming the programmable controller using the remote operator program.

In this way, it is possible to provide a remote program for programming and/or re-programming the programmable controller for example as distinct ‘firmware’, generally as bespoke programs, separate from the operations that are variable by a user, and/or the general operating programs known in the art. The programming may concern any of the non-user operations of the water purification apparatus, such as calibration, updating, interrogation, servicing, component settings, etc., as well as introducing new data or operations or processes, such as a separate water dispense program, into the water purification apparatus.

The programmable controller is preferably arranged to control (in or for the water purification apparatus) at least:

(i) one or more fixed operations. The fixed operations are not variable, and are generally the minimum operations required to run the water purification apparatus;
(ii) one or more user-variable operations. These are variable by a user, usually by the one or more user-operable controls on the water purification apparatus, to provide immediate variation of the operation of the water purification apparatus by a user, usually at the time of dispense; and
(iii) one or more operator-variable operations. These are not variable by a user. They are only variable by an operator, such as a remote operator, but which can be loaded or inputted by a user.

The operator program can vary and/or operate on any one of the above categories, in particular the third category.

The programmable controller and/or one or more other controllers in the water purification apparatus can be arranged to:

(iv) access data, including operator-only accessible data, concerning present and/or past history of one or more functions, operations and/or performances of or in the water purification apparatus, such as the settings and/or performance of one or more of the water purification settings and/or performance of one or more of the water purification components, or the operation, timeline, life or quality of one or more of the water purification components.

Thus, according to another aspect of the present invention, there is provided a water purification system comprising at least:

(i) a water purification apparatus comprising one or more water purification components to provide a purified water stream, preferably having a conductivity of less than 1 μS/cm; and
(ii) a controller in the water purification apparatus able to provide data about the water purification apparatus, and
(iii) a relay to relay the data to a remote operator via the internet.

According to a yet further aspect of the present invention, there is provided a method of relaying data of a water purification system comprising at least the steps of:

(i) providing a water purification apparatus comprising one or more water purification components to provide a purified water stream, preferably having a conductivity of less than 1 μS/cm, a controller in the water purification apparatus able to provide data about the water purification apparatus, and a relay able to relay the data to a remote operator via the internet; and
(ii) relaying the data to a remote operator.

The data can be provided in response to a request for said data from the controller, optionally being the programmable controller or a local drive or interface controller. Such controller request may be a feature of the water purification apparatus or system, and/or at the request of a user and/or operator.

The relay to relay the data to the internet, such as to an internet connection, could be part of the water purification apparatus, or separable therefrom such as a portable memory means such as a USB flash drive.

The internet may be directly or indirectly connected or connectable to the water purification apparatus.

The data may comprise information concerning the present and/or past history of one or more functions, operations and/or performances of the water purification apparatus, such as the settings and of performance of one or more of the water purification components, or the operation, timeline, life or quality of a water purification component

The operator program may be a operator-variable program, such as:

(1) a particular dispense operation or process beyond the availability of the user-operable control(s) and/or interface.
(2) updating of an existing program in a controller.
(3) calibration of a component.
(4) setting of a component.
(5) a sanitisation routine.

Additionally and/or alternatively, the operator program may be to access and acquire data such as:

(1) component data, such as component lifetime, water quality therefrom.
(2) a dispense operation history.
(3) cumulative operational data.

In this way, it is possible for an operator such as a service engineer to directly and/or indirectly (i.e. via the user and/or based on the water purification apparatus itself requesting or prompting a request from the service engineer) work on the water purification apparatus without being present therewith. Remote servicing, updating, data acquisition and/or calibration of one or more operations of the water purification system and/or component(s) therein is therefore possible.

Also possible is the remote provision of an operator program to an operator, which could then be installed by the operator when on site and present at the water purification apparatus. The remote operator program could be provided to an operator such as a service engineer, whether the service engineer is at that time on site or is remote from the water purification apparatus, which service engineer can then install the remotely provided operator program when on site and at the water purification apparatus.

Similarly, an operator could request data about the water purification apparatus when on site, and then relay the data to a remote operator, usually a different operator, via the internet, either whilst still on site or subsequently remote from the water purification apparatus, using a suitable relay.

In this way, the present invention is able to allow an operator such as a service engineer, as well as a user, to be remote from another operator able to program or evaluate data relating to the water purification apparatus.

According to another aspect of the present invention, there is provided a method comprising remotely interacting with a water purification apparatus.

The step of remotely interacting can comprise sending an operator program to operate, optionally also to be stored, on the water purification apparatus to adjust its operation. The operation preferably comprises an operator-variable operation.

The step of remotely interacting can alternatively or additionally comprise relaying data from the water purification apparatus.

The step of remotely interacting can comprise the use of an Internet connection.

The step of remotely interacting can alternatively or additionally comprise the use of a portable memory means such as a USB flash drive.

According to another aspect of the present invention there is provided a method for operation of a water purification apparatus, wherein an operator performs an operation such as an operator task remote from said water purification apparatus.

The operator task can comprise an operator-variable operation. The operator-variable operation can comprise at least one selected from a group comprising:

(1) an operation or process beyond the availability of the user-operable control(s).
(2) updating of an existing program in a controller.
(3) calibration of a component.
(4) setting of a component.
(5) a sanitisation routine.

The operator task can comprise data acquisition. The data can comprise at least one selected from a group comprising:

(1) component data, such as component lifetime, water quality therefrom.
(2) a dispense operation history.
(3) cumulative operational data.

One or more of the above methods allow an operator to act remotely from the water purification apparatus. Conventionally, operator tasks or functions such as servicing, repair, etc., or obtaining certain operational data, have only been able to be carried out by the physical presence of an operator. Even some service engineers, especially those operating in remoter locations, have had at times insufficient operability and/or access to a water purification apparatus without further onsite assistance.

Thus, an advantage of the present invention is to reduce, and optional eliminate, the need for the physical presence of a service and operator personnel, such as site visits, lowering OPEX, and also extending the geographical reach of operators of water purification apparatus, and reducing service charges and the like for users of water purification apparatus.

The water purification apparatus may be pre-programmed to prompt a user to pass data from the water purification apparatus to a remote operator, or the user may ask the water purification apparatus to collect or collate data to be relayed to a remote operator, either routinely or specifically, for example for troubleshooting after a component or operation query or fault.

The term “user” as defined herein relates to a person (being singular or plural) desiring to obtain a dispense of the purified water stream from the water purification apparatus for subsequent use of the purified water in an operation or process.

The term “operator” as used herein refers to a person (being singular or plural) able to provide a computer program to access and/or vary the operator-variable operations on the programmable controller and/or the accessible data in the water purification system. There is generally no overlap between users and operators except where for example an operator requires a dispense of the purified water to install, repair, maintain and/or service or otherwise test the water purification apparatus, or where certain data is also accessible to a user. An operator providing the operator program may or may not be the same person as an operator able to install, repair, maintain and/or service or otherwise test the water purification apparatus.

The interface of the programmable controller and/or another controller can comprise a parallel or serial communication interface but in a preferred embodiment comprises a serial communication interface.

Any suitable serial communication interface can be used, including wired and wireless communication interfaces. Examples include without limitation Universal Serial Bus (USB); FireWire, I²C; SPI; SCSI.

In one embodiment, the interface comprises a USB communication interface.

The term “USB” as used herein encompasses all USB specifications including past, present and future variations, for example USB 1.0, 1.1, 2.0, 3.0 and Wireless USB.

There are various ways in which the interface can receive the operator program. In a first embodiment, the interface is arranged to receive a portable memory means. The portable memory means preferably comprises a non-volatile memory (NVM), which can for example be any type of ROM; Flash memory including either NOR or NAND Flash; any type of magnetic memory or any type of optical disc drive.

The portable memory means can comprise a memory stick, a memory card, or other portable storage means.

Preferably, the water purification apparatus comprises a USB socket.

Preferably, said USB socket is arranged to receive a USB Flash drive (also known as a “memory stick”).

In one embodiment, the USB Flash drive has instructions stored on it which form the operator program. The interface of the programmable controller is preferably arranged to commence an enumeration process upon insertion of the USB Flash drive and then to transfer the operator program from the USB Flash drive to a memory of the programmable controller.

Optionally, the programmable controller can receive the operator program via one or more intermediate flash memories, so as to be able to carry out checks before uploading the program into programmable controller.

In another embodiment, the USB flash device is able to receive data, either from the programmable controller or another controller, and then to relay the data to a remote operator via the internet, usually via a computing device in a known manner.

In another embodiment of the present invention, the interface of the programmable controller is arranged for connection with a computing device.

The computing device comprises a memory means on which the operator program can be stored. The computing device can for example be a desktop personal computer, a laptop, personal digital assistant (PDA).

Preferably, the water purification apparatus comprises a USB socket for USB connection with the computing device.

The computing device optionally includes an operator interface for the authoring of an operator program.

Alternatively or additionally, the computing device comprises a modem (wired or wireless) for connection to the Internet or other computer network. The operator program and/or data can be transmitted through the internet or other computer network to and from the computing device.

In a third embodiment, the water purification apparatus comprises an integral computing device comprising memory means on which the operator program and/or data can be stored. The integral computing device preferably includes an operator interface for the authoring of an operator program, and/or accessing data.

Alternatively or additionally, the integral computing device also comprises a modem (wired or wireless) for connection to the Internet or other computer network. The operator program and/or data can be transmitted through the internet or other computer network to and from the computing device.

Preferably, said integral computing device also connects to a USB socket. This socket can be used to receive an operator program that is authored elsewhere, and/or transmit data.

According to a third aspect of the present invention, there is provided a water purification apparatus comprising at least:

(i) a water purification apparatus comprising one or more water purification components to provide a purified water stream, preferably having a conductivity of less than 1 μS/cm; and
(ii) a USB socket connected to the apparatus for permitting data to be transferred to and/or from the apparatus via the socket, preferably between a separable USB Flash drive and the apparatus.

Such a water purification apparatus is able to accept any unit, apparatus, device, lead, etc having a USB plug, such as a USB Flash drive.

According to a fourth aspect of the present invention, there is provided a water purification system comprising at least:

(i) a water purification apparatus comprising one or more water purification components to provide a purified water stream, preferably having a conductivity of less than 1 μS/cm; and
(ii) a portable memory means, preferably a USB Flash drive, connectable to the water purification apparatus for supplying commands to or receiving data from the apparatus.

The water purification apparatus of the present invention may comprise any number of water purification components, as well as other devices, parts, lines, etc, including but not limited to one or more of the following: pumps, meters, oxidisers, sensors, de-ionisers, valves, drains, controllers, control units, control mechanisms, taps, reservoirs, recirculation loops, filters and membranes. One or more of such components may be integral with the water purification apparatus, such as a pump, and one or more of such components may be separable from the water purification apparatus, such as an ion-exchange cartridge.

Water purification apparatus are known in the art, and are generally intended to provide purified water, preferably as a purified water stream, having a conductivity of less than 1 μS/cm, preferably less than 0.1 μS/cm, more preferably less than 0.067 μS/cm, at 25° C. This can be equated to the purified water stream having a resistivity of at least 1 MΩ-cm, preferably at least 10 MΩ-cm, more preferably at least 15 MΩ-cm. Additionally, purity specifications can be made for organic species to content levels of less than 500 ppb of total organic carbon (TOC), preferably less than 50 ppb; bacteria to levels less than 100 colony forming units (cfu) per millilitre, preferably less than 1 cfu/ml; and for dissolved oxygen and/or particles.

Such water purification apparatus generally only provide up to 1000 litres of purified water per hour, such as up to 5 l/min.

Such water purification apparatus are generally ‘stand alone’ units, generally only requiring connection to nearby water and electricity supplies to be operable. Thus, they are generally independent and/or moveable units operating in or at a specific location such as a laboratory. Preferably, at least the majority of the purification actions or processes occur within a housing. They are intended to provide a purified water stream only, such stream not being in combination with any other substance or compound.

In general, a water purification apparatus includes a pump, an inlet, one or more de-ionisers, optionally one or more oxidisers, and a water outlet (for dispense of the purified water).

One common oxidiser involves the use of ultraviolet light, and the ultraviolet treatment of water for decomposing organic compounds or substances in water is well known in the art. Apparatus and instruments for providing suitable ultraviolet light are well known in the art, and typically involve emitting ultraviolet light at one or more specific wavelengths in an area or space through which the water passes. The or each oxidiser can be provided as a distinct component, typically a separable component such as a replaceable cartridge, having an ultraviolet emitter therein around which the water stream passes from an inlet to an outlet. The purification of water in the present invention may involve one or more oxidisers, being in series, parallel or both.

Ionic species of the feedwater (and any created by any oxidiser(s)) are generally removed from the water stream to provide purified water by the use of one or more de-ionisers. Many types and forms of de-ioniser are known in the art, and include, but are not limited to, one or more of the following; (electro)deionisation apparatus or units, reverse osmosis (RO) units or apparatus, membranes, filters, ion exchange resins and zeolites. The action and operation of de-ionisers is well known in the art, and they are not further described in detail herein.

The water purification apparatus may comprise a plurality of ion-exchangers, including one or more “pre-treatment” ion exchangers upstream of any oxidiser, as well as one or more ion-exchangers downstream of any oxidiser.

The dispense of at least a portion of the purified water from the water purification apparatus can be provided through any form or type of outlet or outlets, optionally being co-ordinated or separate.

The water purification apparatus may have a dispense mode or other such form of operation, and a recirculation mode. Preferably, the or each point of dispense of the purified water involves at least one valve, more preferably operable between a dispense position and a recirculating position. One or more valves may also provide control over the volume and/or rate of flow of the purified water at the dispense.

The movement of water through a water purification apparatus is generally provided by the use of one of more pumps known in the art, and the nature and operation of a pump is not further discussed in detail herein.

The remote operator control commands of the system of the present invention may also include a program for storing on the programmable controller, and/or operational instructions for overriding user-operable controls, in particular the control limits.

According to another aspect of the present invention, there is provided a system for controlling a water purification apparatus, the water purification apparatus comprising one or more water purification components to provide a purified water stream, the apparatus having user-operable controls; a programmable controller in the water purification apparatus and connected to the user-operable controls for receiving control commands from the controls, the programmable controller configured to control the water purification apparatus in response to the control commands; a data interface for receiving operator command controls for controlling operation of the apparatus; and

a communication device removably connectable to the data interface, the communication device including a storage medium containing programmable logic, the communication device adapted to provide remote operational control commands to the apparatus for controlling the operation of the apparatus.

According to another aspect of the present invention, there is provided a process for remotely controlling a water purification apparatus comprising the steps of:

providing a water purification apparatus comprising one or more water purification components to provide a purified water stream, the apparatus having one or more user-operable control(s); a programmable controller in the water purification apparatus and connected to the user-operable controls for receiving control commands from the controls, the programmable controller configured to control the water purification apparatus in response to the control commands; a data interface for receiving operator command controls for controlling operation of the apparatus;
removably connecting a communication device to the data interface, the communication device including programmable logic for providing remote operational control commands to the apparatus for controlling the operation of the apparatus;
transmitting operational control commands to the apparatus from the communication device for controlling the operation of the apparatus, the operational control commands being in addition to or distinct from the commands stored on or communicatable from the programmable controller.

In such a process, the operational control commands may be programs for updating the programmable controller and the process may further comprise the step of storing the operational control commands on the programmable controller for use in future control of the apparatus. The operational control commands may also be programs for overriding user-operable control limits and/or include a program for retrieving data from the apparatus, and the process comprises the step of retrieving data from the apparatus corresponding one of more of the following:

component data including the component use and water quality;
a dispense operation history; and
cumulative operational data.

The present invention encompasses all combinations of various embodiments or aspects of the invention described herein. It is understood that any and all embodiments of the present invention may be taken in conjunction with any other embodiment to describe additional embodiments of the present invention. Furthermore, any components of an embodiment may be combined with any and all other components from any of the embodiments to describe additional embodiments.

Embodiments of the present invention will now be described by way of example only and with reference to the accompanying drawings in which:

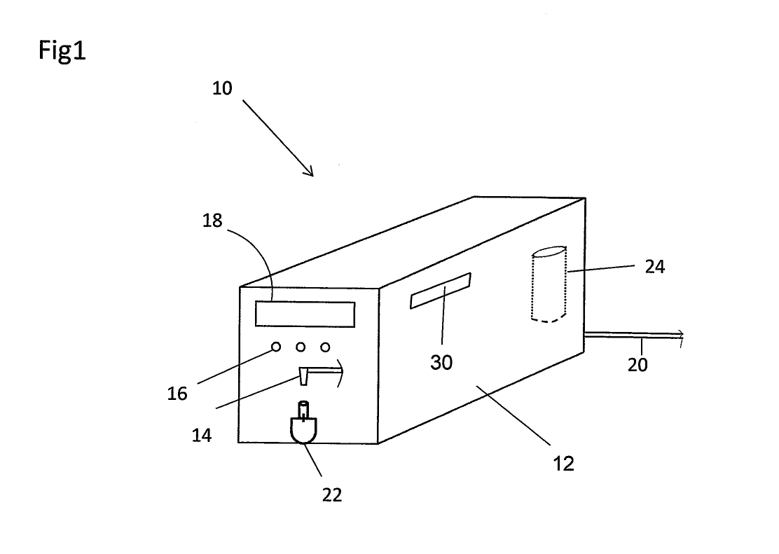

FIG. 1 is a diagrammatic perspective view of the water purification apparatus according to one embodiment of the present invention;

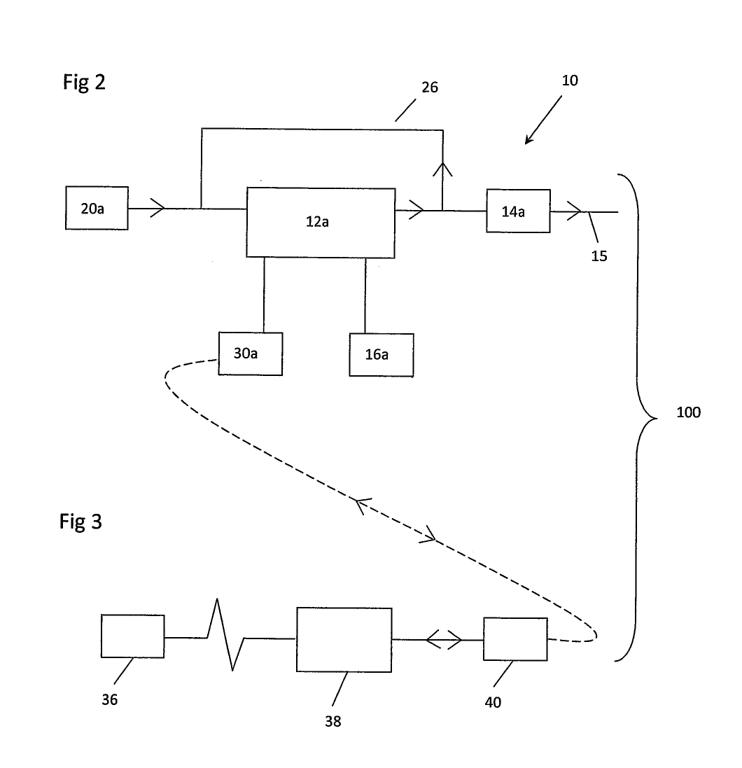

FIG. 2 is the schematic layout of the water purification apparatus of FIG. 1;

FIG. 3 is a schematic layout of components of a water purification system useable with FIG. 2 to provide a system according to one embodiment of the present invention; and

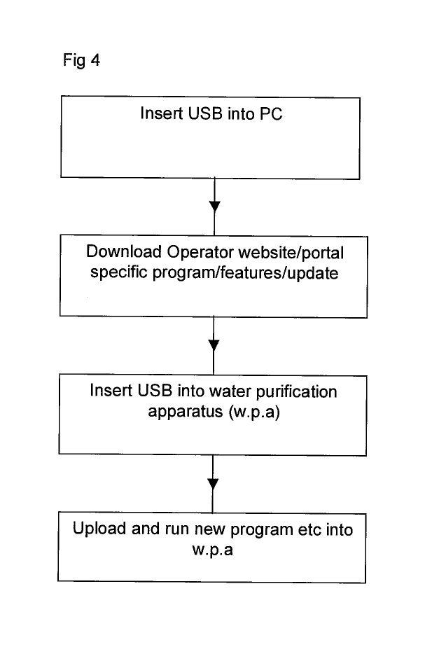

FIG. 4 is a flow diagram of a system according to another embodiment of the present invention.

Referring to the drawings, FIG. 1 shows a water purification apparatus 10. The water purification apparatus 10 comprises a housing 12, a water dispense point 14, user-operable controls 16, a display 18. FIG. 1 also shows a water inlet 20, a vessel 22 for receiving a dispense of water from the water dispense point 14, and the location of a separable cartridge 24.

The water purification apparatus also comprises a programmable controller (not shown) for receiving an operator program, and usually for storing said program in the programmable controller. FIG. 1 also shows a socket 30 as the interface. The interface can comprise any suitable parallel or serial communication interface.

Within the housing 12, there are one or more water purification components such as those described hereinabove. Such components may be integral and/or separable from the housing 12. Separable components include ion-exchange cartridges and UV cartridges known in the art, but the present invention is not limited by the number, nature or location of the water purification components in the housing 12. The optional location of such a cartridge 24 is shown for illustrative purposes only. The operations of water purification components are well known to those skilled in the art, and are generally intended to reduce and/or remove contaminants and impurities in water provided from a water input 20, so as to provide a purified water stream from a water dispense point 14.

Water purification components can include physical, magnetic, electrical and/or light-based components in any arrangement or line-up known in the art.

The water purification apparatus 10 is typically intended to be located on or near a work bench, optionally supported thereby or self-supporting. A water purification apparatus may include one or more water inlets, generally from a single source such as a tap or other potable water supply, and to provide one or more water dispense points. FIG. 1 shows a single water dispense point 14 integral with the water purification apparatus 10 by way of example only. Water dispense points can be movable relative to the housing 12, and/or located in remote locations such as through water supply piping or conduits such as a ring main to one or more remote locations, such as a separate room, workbench or laboratory.

The example of the water purification apparatus 10 shown in FIG. 1 comprises three user-operable controls 16, optionally as rotatable dials. Typical operations for user-operable controls include variation or setting of a desired volume of water, desired speed of dispense, and/or desired quality of purified water.

The example of the water purification apparatus 10 shown in FIG. 1 also shows a display 18, optionally able to display variable parameters changeable by the user-operable controls 16, as well as parameters concerning the water purification apparatus 10 such as current water purity level, or at least a required minimal level, operational status of one or more parts of the apparatus, etc.

The water purification apparatus 10 shown in FIG. 1 includes a programmable controller, such as a microcontroller or other Integrated Circuit (not shown) which is arranged to control one or more fixed operations, and one or more user-variable operations, in particular variable according to the user-operable controls 16.

The water purification apparatus shown in FIG. 1 includes a USB socket 30, able to accept and/or connect to a device, unit, lead, etc. having a USB plug. This includes a direct device such as a USB Flash drive, or a lead having a USB plug for connecting the USB socket 30 to another device.

FIG. 2 figuratively represents the water purification apparatus of FIG. 1 in a water purification system 100 along with FIG. 3.

In FIG. 2 the water input 20a provides a source of water into the housing 12a, which is then able to purify the water to provide a purified water stream to a water dispense point 14a for use by a user in a subsequent operational process (represented by line 15).

FIG. 2 also shows a recirculation stream 26 able to recirculate purified water (usually within the housing 12a, but shown in FIG. 2 outwith the housing 12a for clarity purposes). The nature and operation of a recirculation stream with or in connection with a water purification apparatus is well known in the art, and generally allows the water purification apparatus to maintain a level or quality of water purification during times of non-dispense, avoiding water in the water purification apparatus becoming static, and therefore possibly stagnant as known in the art.

FIG. 2 shows a user interface 16a involving the user-operable controls 16 shown in FIG. 1. Operation of the user interface 16a allows a user to vary the user-variable operations of the controller within the housing 12a in a manner known in the art. FIG. 2 also shows a USB socket 30a, able to accept and/or connect to a device, unit, lead, etc. having a USB plug.

FIG. 3 shows components usable to provide a water purification system 100 according to one embodiment of the present invention in combination with the components shown in FIG. 2.

In FIG. 3, there is shown schematically an operator 36 who as herein described above is able to author and/or provide a remote computer program to vary the operator-variable operations on the programmable controller in the water purification apparatus 10. Using the internet or other computer network, the operator 36 is able to transmit from a remote location the program to the computing device 38, such as a personal computer, laptop or personal digital assistant (PDA), which comprises a memory means on which the program can be stored. This enables the operator 36 to provide a program to the water purification apparatus 10 even when the operator 36 is remote from the water purification apparatus 10.

The computing device 38 may be directly and/or physically connected or connectable to the water purification apparatus 10. Optionally, the computing device 38 includes one or more sockets or ports, such as but not limited to a USB socket, able to connect to a portable memory means 40. The portable memory means 40 can then be used to transfer a computer program or other software provided by the operator 36 via the computing device 38 to the water purification apparatus 10.

In one example, the portable memory means 40 is a USB Flash drive, having a USB plug which is able to connect with the interface of the programmable controller via the socket 30a shown in FIG. 2.

In this way, the operator 36 is able to provide a user of the water purification apparatus 10, usually also the user of the computing device 38, with an operator program, which can be transferred to the water purification apparatus 10 via the portable memory means 40, in order to allow the water purification apparatus 10 to operate an operator-variable process.

By way of example only, the operator program may be a particular dispense operation or process beyond the availability of the user-operable controls and/or interface. The objectives or desire of the request can be relayed to the operator 36 via the computing device 38, such as a computer connected to the internet, and the appropriate water dispense program can be delivered to the user by the operator 36 from the operator's location and in such a way that the operator is confident that installation of the operator-variable program suits and conforms with the water purification apparatus 10. For example, a user may require an exceptional volume of purified water, and the operator 36 can provide a distinct program able to provide such water of the required purity over a period of time, taking into account other requirements or users or uses of the water purification apparatus in the meanwhile.

FIG. 4 represents a flow diagram of such an example, whereby a user of the water purification apparatus inserts a USB flash drive into a suitable computer, generally being a PC, and generally being connectable to the internet or another communications system with a remote operator. The user and/or the remote operator can then download onto the USB flash drive, generally from the operator website or other portal, a specific program or feature or update to be loaded and programmed into the water purification apparatus.

Such programs/features/updates could include a calibration or recalibration of one or more metres or sensors such as a total organics content (TOC) calibration, or a revised sanitation timetable or schedule, or the like, generally being either a program/feature/update that a user should not be able to program the water purification apparatus to do themselves, or which the remote operator wishes the user to specifically have in a timely manner (such as calibration updates), or one which the user specifically wishes to have for that user, such as a specific purpose or operation of the water purification apparatus which may require additional cost compared to the basic provision of the water purification apparatus. All such programs/features/updates are provided as ‘firmware’ for particular programming of the programmable controller(s) in the water purification apparatus.

By way of another example, the operator program may be to check or recalibrate or set or reset a component such as a pump, primer, etc.

Thus, the present invention can provide a system and apparatus whereby an operator, usually remotely located, can provide to the user a program for the water purification apparatus which is different to any user-variable operations. Generally, the operator is the manufacturer, service provider, maintenance provider or other emergency support for the water purification apparatus, who is able to provide operator-variable operations to the water purification apparatus which can collude with existing processes, especially the fixed operations, in the water purification apparatus without affecting its existing operations and processes. The provision of operable-variable operations may be at the request of the user, or at the request of the operator to assist operation and/or updating of the water purification apparatus, either routinely or to assist servicing, maintenance or repairs.

The system and apparatus of the present invention also allow the transfer of data such as performance data from the water purification apparatus to be provided to an operator, usually a remote operator, such as via the internet, to assist information flow between the water purification apparatus and the service, maintenance and/or repair provider or engineer. A user (or at least a local drive controller) is able to load performance data from the water purification apparatus onto the USB Flash drive 30a, which can then be relayed to an operator. In this way, the operator can check, either at the request of the user or the apparatus itself, a process or operation or performance of the water purification apparatus, such as correct working of a component, or the remaining lifetime of a component, or the correct operation of the water purification apparatus by a user, etc.

It will be appreciated that although specific embodiments of the invention have been described herein for the purposes of illustration, various modifications may be made without deviating from the spirit of the scope of the invention.

1. A water purification system comprising at least:
(a) a water purification apparatus comprising one or more water purification components to provide a purified water stream, the apparatus having one or more user-operable controls;
(b) a programmable controller in the water purification apparatus, and connected to the user-operable control(s) for receiving control commands from the controls, the programmable controller configured to control the water purification apparatus in response to the control commands; and
(c) a data interface for receiving a remote operator program from a detachable communication device for controlling operation of the apparatus.

2. A water purification system as claimed in claim 1 wherein the data interface comprises a USB communication interface.

3. A water purification system as claimed in claim 1 wherein the remote operator program comprises one or more of the following:
(1) an operation or process beyond the availability of the user-operable controls;
(2) updating of an existing program in the controller;
(3) calibration of a component;
(4) setting of a component; and
(5) a sanitisation routine.

4. A water purification system comprising at least:
(i) a water purification apparatus comprising one or more water purification components to provide a purified water stream having a conductivity of less than 1 μS/cm;
(ii) a controller in the water purification apparatus able to provide data about the water purification apparatus; and
(iii) a relay to relay the data to a remote operator via the internet.

5. A water purification system as claimed in claim 4 wherein the relay includes a USB flash device able to receive and at least partly relay the data to the remote operator.

6. A water purification system as claimed in claim 4 wherein the data comprises one or more of the following:
(1) component data such as a component lifetime and/or water quality therefrom;
(2) a dispense operation history; and
(3) cumulative operational data.

7. A water purification system as claimed in claim 4 wherein the water purification apparatus includes a USB socket.

8. A water purification system as claimed in claim 7 wherein the USB socket is arranged to receive a USB Flash drive.

9. A water purification system comprising at least:
(i) a water purification apparatus comprising one or more water purification components to provide a purified water stream, preferably having a conductivity of less than 1 μS/cm; and
(ii) a USB socket connected to the apparatus for permitting data to be transferred between a separable USB Flash drive and the apparatus.

10. A water purification system comprising at least:
a water purification apparatus comprising one or more water purification components to provide a purified water stream having a conductivity of less than 1 μS/cm; and
(ii) a portable memory means connectable to the water purification apparatus for supplying commands to or receiving data from the apparatus.

11. A water purification system as claimed in claim 1 wherein the water purification apparatus comprises one or more of the following: pumps, meters, oxidisers, sensors, de-ionisers, valves, drains, controllers, control units, control mechanisms, taps, reservoirs, recirculation loops, filters and membranes.

12. A water purification system as claimed in claim 1 wherein the water purification apparatus includes a pump, a water inlet, one or more de-ionisers, and a water outlet.

13. A water purification system as claimed in claim 1 wherein the water purification apparatus is a stand-alone laboratory unit.

14. A water purification system as claimed in claim 1 wherein the remote operator program includes operational instructions for overriding user-operable controls.

15. A system for controlling a water purification apparatus, the water purification apparatus comprising one or more water purification components to provide a purified water stream, the apparatus having user-operable controls; a programmable controller in the water purification apparatus and connected to the user-operable controls for receiving control commands from the controls, the programmable controller configured to control the water purification apparatus in response to the control commands; a data interface for receiving operator command controls for controlling operation of the apparatus; and a communication device removably connectable to the data interface, the communication device including a storage medium containing programmable logic, the communication device adapted to provide remote operational control commands to the apparatus for controlling the operation of the apparatus.

16. A water purification system as claimed in claim 6 wherein the remote operator program includes operational instructions for overriding user-operable controls.

17. A water purification system as claimed in claim 9 wherein the remote operator program includes operational instructions for overriding user-operable controls.

18. A water purification system as claimed in claim 10 wherein the remote operator program includes operational instructions for overriding user-operable controls.

19. A water purification system as claimed in claim 13 wherein the remote operator program includes operational instructions for overriding user-operable controls.
